(19) United States
(12) Patent Application Publication
(10) Pub. No.: US 2015/0149230 A1
(43) Pub. Date: May 28, 2015

(54) PLAYDATE SCHEDULING SYSTEM

(71) Applicants: MERYL JEAN NEIMAN, Columbus, OH (US); Lisa Baslow, Nyack, NY (US)

(72) Inventors: MERYL JEAN NEIMAN, Columbus, OH (US); Lisa Baslow, Nyack, NY (US)

(21) Appl. No.: 14/090,672

(22) Filed: Nov. 26, 2013

(51) Int. Cl. G06Q 10/10; G06Q 50/00

(52) U.S. Cl. CPC G06Q 10/1095; G06Q 50/01
USPC 705/7.19

(57) ABSTRACT

A social scheduling system includes member profile information. Each member profile includes information about a member and one or more of the member's associated entities. For example, a member/associated entity pair may be parent/child. In some embodiments, the system may allow a host to create an event invitation that includes a number of spaces, send the invitation to a number of invitees, and retrieve acceptances until the number of spaces has been filled. After the spaces have been filled, the system may notify the host and/or the remaining invitees. In some embodiments, the system may enable users to identify associated entities who have special needs that may conflict with a characteristic of the event. For example, if an invited entity has a food allergy and the event will include food, the system may alert the host and/or the invited entity's associated member of the potential conflict.

### PRIORITY CLAIM

The present application claims the benefit of and priority to Provisional U.S. Patent Application Ser. No. 69/729,806, filed Nov. 26, 2012, entitled “Social Scheduling System.”

### BACKGROUND

Kids and parents have very busy schedules. The tasks required to call, email or otherwise message a group of kids and/or parents in order successfully coordinate a get-together can be extremely difficult and time consuming. For example, a parent might have to make multiple phone calls or send and receive multiple e-mails to find a child whose schedule matches that of her child. If the parent did not have a long lead time before the desired date, she might be unsuccessful in securing a play companion for her child. Alternatively, if the parent were to invite many children simultaneously to increase the odds of success, she might end up with more positive replies than her space at home can accommodate.

The inventors have identified a need for a solution that reduces the hassles and time associated with social planning. This document describes systems and methods that present solutions to the problems discussed above, and which may also provide additional benefits.

### SUMMARY

In one embodiment, a social scheduling system includes a data set of member profile information. Each member profile includes information about a member, or about a member and one or more of the member's associated entities. For example, a member may be a parent, and the associated entity may be a child. The system may allow a host to create an event invitation that indicates a finite number of spaces for acceptance, send the invitation to a number of invitees, and receive acceptances until the number of spaces has been filled. After the spaces have been filled, the system may notify the host and/or the remaining invitees.

In some embodiments, a social scheduling system may enable users to create invitations about social events and send the invitations to one or more members and/or their associated entities. The system may identify associated entities who have special needs that may conflict with a characteristic of the host, the location or another aspect of the event. For example, if an invited entity has a food allergy and the event will include food, the system may alert the host and/or the invited entity's associated member of the potential conflict.

### BRIEF DESCRIPTION OF THE DRAWINGS

FIG. 1 illustrates an example of a home page of a scheduling interface.

FIG. 2 illustrates an example of a log-in page of a scheduling interface.

FIG. 3 illustrates an example of user profile page of a scheduling interface.

FIG. 4 illustrates an example of an associated entity profile screen.

FIG. 5 illustrates an example of an associated entity's social interface.

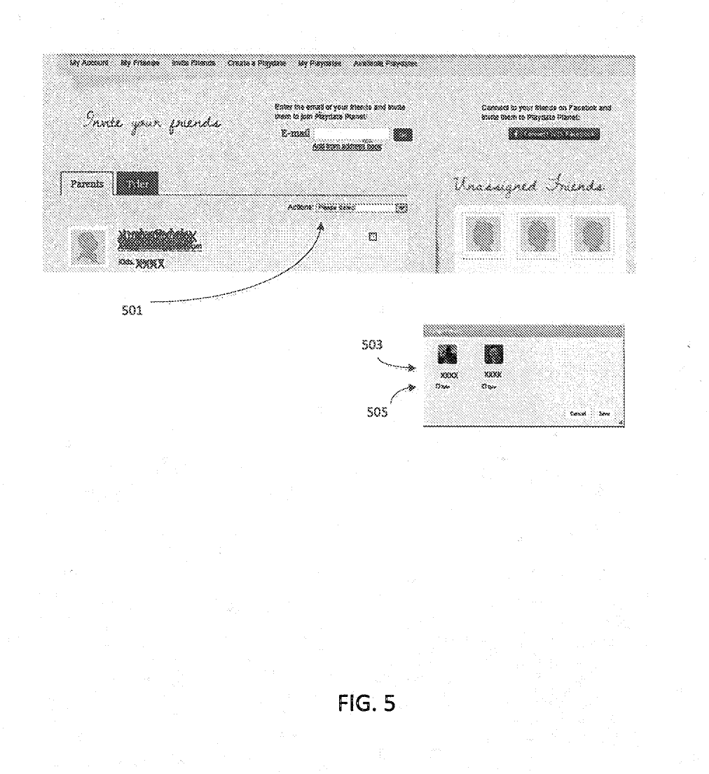

FIG. 6 illustrates an example of a group affiliation interface.

FIG. 7 illustrates an example of an event creation interface.

FIG. 8 illustrates an example of a social event invitation.

FIG. 9 illustrates how the system may monitor acceptances and compare the acceptances to the available spaces for an event.

FIG. 10 is a block diagram showing various equipment that may be used to implement various embodiments of the processes described in this document.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used in this document have the same meanings as commonly understood by one of ordinary skill in the art. As used in this document, the term “comprising” means “including, but not limited to.”

As used in this document; the term “electronic device” refers to a device that includes a processor and tangible, computer-readable memory. The memory may contain programming instructions that, when executed by the processor, cause the device to perform one or more operations according to the programming instructions. Examples of electronic devices include personal computers, gaming systems, televisions, and portable electronic devices such as smart phones, personal digital assistants, cameras, tablet computers, laptop computers, media players and the like. The term “electronic communication” refers to the ability to transmit data via one or more signals between two or more electronic devices, whether through a wired or wireless network, and whether directly or indirectly via one or more intermediary devices.

This document describes a social scheduling system that fosters and expedites the posting and accepting of social events, such as traditional in-person play dates for children who are friends. The system may be implemented via a website or mobile electronic device application that is accessible to users of a social network.

The system may include a data storage facility, i.e., a database or other data structure in one or more computer-readable media, such as non-transitory computer-readable program code, wherein member profiles for members of the social network are stored. The member profiles may include information identifying the member as well as at least one associated entity. For example, the member may be a parent or guardian, and the associated entity may be a child or pet. The system also may include a scheduling module that includes a processor and/or computer-readable instructions contained on a computer-readable medium that, when executed, instruct the processor to implement a scheduling interface.

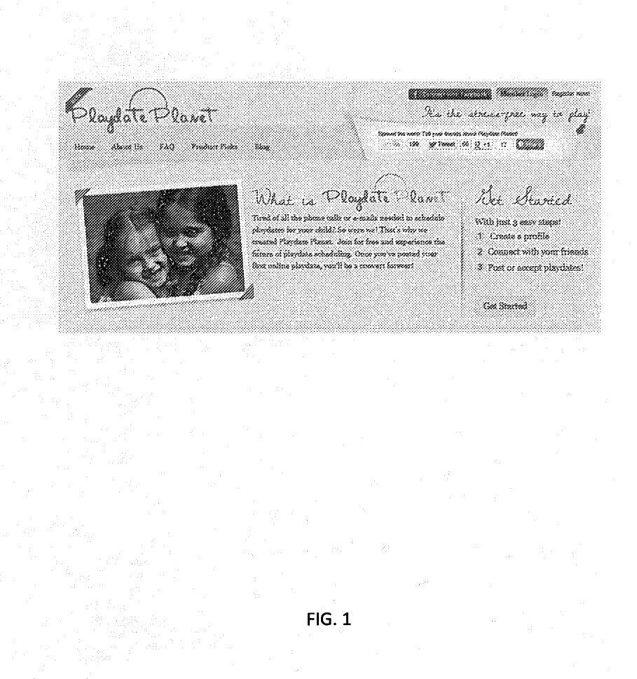

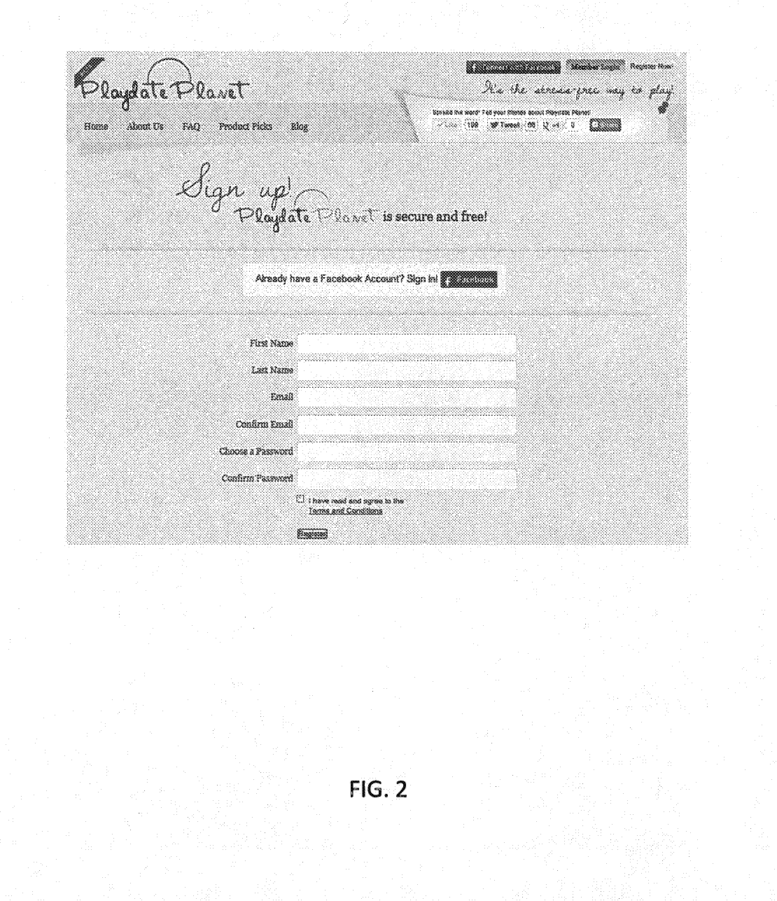

FIG. 1 is a screen-shot of an example of a home page of a scheduling interface, in this case implemented as a website. To use the scheduling interface, an individual may first be required to join the network. As shown in FIG. 2, the system may allow users to join by signing in and entering a user identifier (such as a name, e-mail, or biometric identifier) and/or access code. Alternatively, the system may allow users to use access credentials that are affiliated with a third party network such as a social network or an e-mail account.

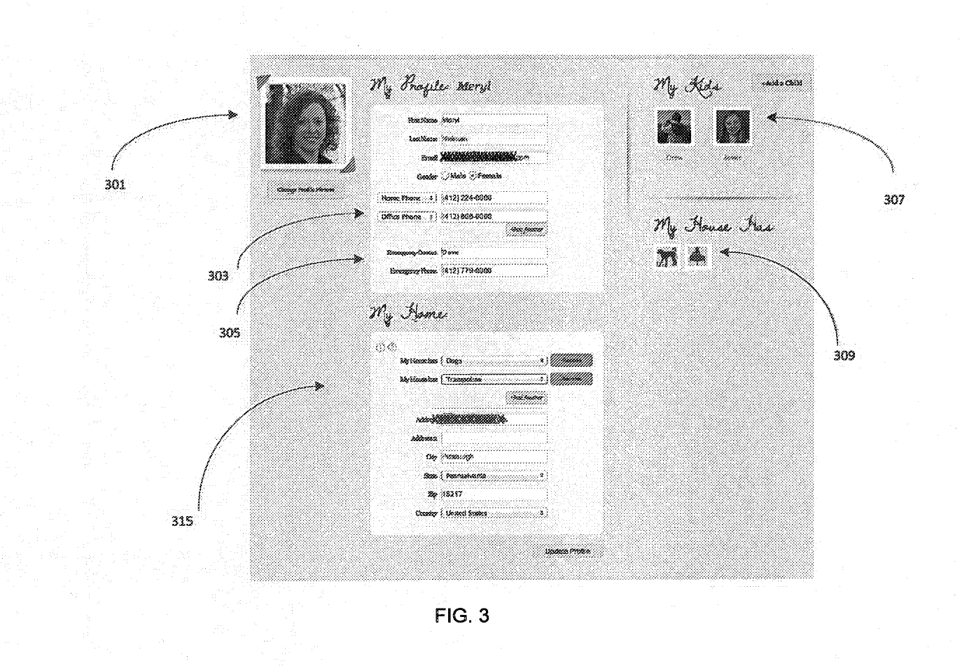

The scheduling module may require each user to create a profile, as illustrated by example in the user profile screen shot of FIG. 3. The profile information 301 is then captured in the database. For example, the user may enter information such as name, e-mail, and gender. Optionally, the member can also add additional information that may be helpful to the planning of the social event. For example, in the case of the play date, the parent member can add telephone numbers 301, emergency contact names and numbers 303, and to aid with play date hosting, information about his or her home and/or the event itself. The member may be enabled to upload a photo of the member 305 and/or the child 307 or other associated entity from his or her electronic device. If the member does not choose to do so, the scheduler may assign him/her an avatar based on the indicated gender.

The system allows for the capture of additional information relevant to the social context. For example, in its use as a play date scheduler, the member can add information about the social event or event site 315 (e.g., the host member's home) such as whether the member has dogs, cats, a trampoline, or a pool. In various embodiments, this information may be entered from a menu such as a drop-down menu, entered as free-form text, or otherwise entered. When free-form text is entered, in some embodiments, the system may add an item corresponding to that text to the menu for future use as the need arises. The system saves information captured in the data storage facility. Some or all of the information may be included in a social invitation and/or made available to appear in the form of icons 309 or other indicia that will be visible to anyone receiving an invitation from that member. If the member enters a home address here, that information also may be captured in the database so that the system can automatically populate a data entry form with that information when the member is creating a social event that takes place or originates at his or her home.

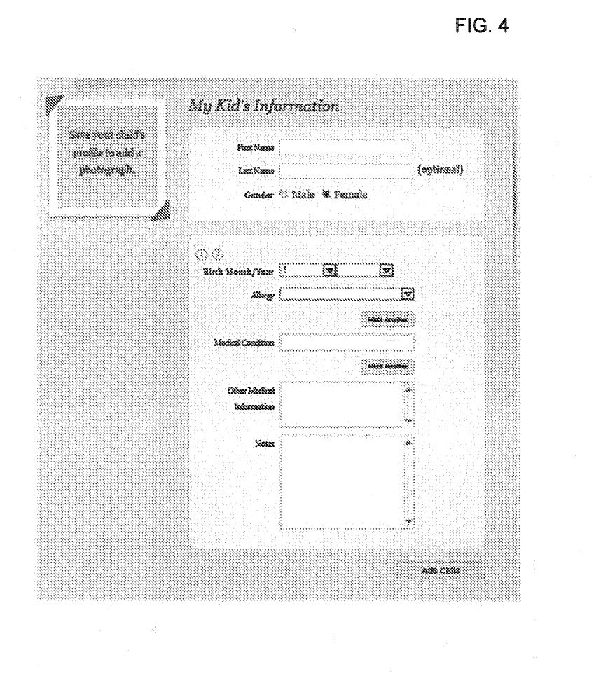

In some embodiments, the system may enable the member to add profile(s) for any associated entities, such as additional family members, pets, etc. who may be participants in a future social engagement. FIG. 4 illustrates an example of an associated entity profile screen. For example, in the play date usage of the social scheduling system, the member may be required to include the child's first name, his/her gender, and birth month and year.

As with the original member profile, the information regarding each associated entity's profile will be included in the database. The member may upload a photo or, in the case of a child, an avatar may be assigned based on the child's gender.

The associated entity's profile may include special needs information about the entity. Special needs information may include allergies, physical limitations, or other information that the host should know in order to safely host the entity at the event. For example, in the context of the play date scheduler, the parent may be able to input and/or select from a set of allergies or add in any other medical condition or information. For example, the system may display a selectable list that contains common allergies, and the list may be augmented or updated as needed. In that manner, a parent may be able to record the facts that their child is allergic to peanuts and carries an epi pen. That information would then travel with the child's profile and be readily available to any parent hosting that child on a play date. The database also may identify and generate an alert if it discovers any perceived conflict between a child's allergy and a characteristic of the social event (e.g., a characteristic of the host's home such a pet or wheelchair accessibility identifier, or a characteristic of the event such as an activity that will be performed or a food that will be served). For example, if a child is allergic to dogs and the host's home has a dog, a warning message may be presented to the invitee, the host or both to indicate that if the child's parent accepts a play date at that home, the parent and/or host are alerted to the possible danger so they can decide whether to go forward with the play date. In the dog play date context, child allergy or medical information could be replaced with relevant information about a dog such as vaccinations, aggressiveness, fearfulness, etc.

The member can add as many children or other social participants as she likes and each may have his/her own profile, enabling the member to schedule social events individually for each associated entity.

The social scheduler system may require that members connect with one another before posting and accepting invitations. Members can connect either by using the network itself, by a social networking application, by importing any popular e-mail address book, or by manually entering one or more e-mail addresses. Members can invite friends individually or in bulk. Friends will then receive an e-mail or other message inviting them to join the network and connect. In some embodiments, the system may be set up as a means to connect with pre-existing friends. In other embodiments, the system may add the capability to engage in play dates with “new” friends, such as by adding a consent field where members could opt-in to agree for their profile and/or information about their associated entity to be searchable by other members.

In some embodiments, the system may include a function that enables members to invite new friends directly through a social invitation. If a person who is invited to a social event chooses to accept that invitation, that person may then be required to complete a profile so that their information is captured and stored in the database.

In some embodiments, the system may include a function through which a member may assign social connections to him/herself, or her associated entities. In this way, the member can post social invitations on behalf of an associated entity. For example, in a play date scheduling site, a scheduling interface may include a command 501 by which a member can assign the children of her connections 505 to one or more of her children 503, allowing for easy and convenient play date scheduling without having to comb through the entire pool of connections.

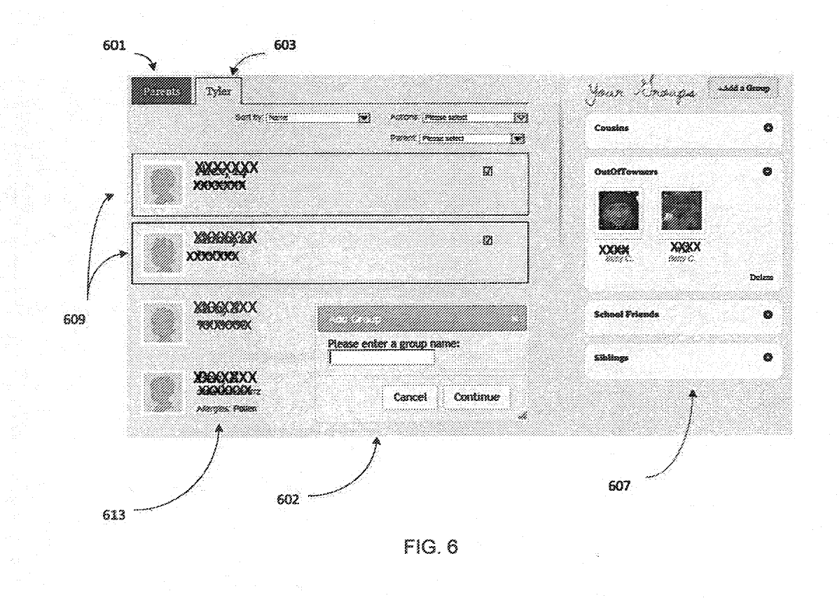

Once social connections are assigned, as illustrated in FIG. 6, the system may allow the member to create and label groups and add or delete connections to these groups. The groups may be saved in the database to be recalled and available when creating social invitations. For example, the system may provide an interface for the member 601 and each of the member's associated entities 603. The interface for each individual may display the groups 607 that are associated with the individual. The system may also include an interface through which a user may create a new group 602 and select from a set of friends 609 to assign to a new or existing group. Note that FIG. 6 also shows that an associated entity's profile may include a special needs identifier 613, such as a food or other allergy, a physical or mental limitation, or a required physical accommodation. The use of such an identifier will be described in more detail below.

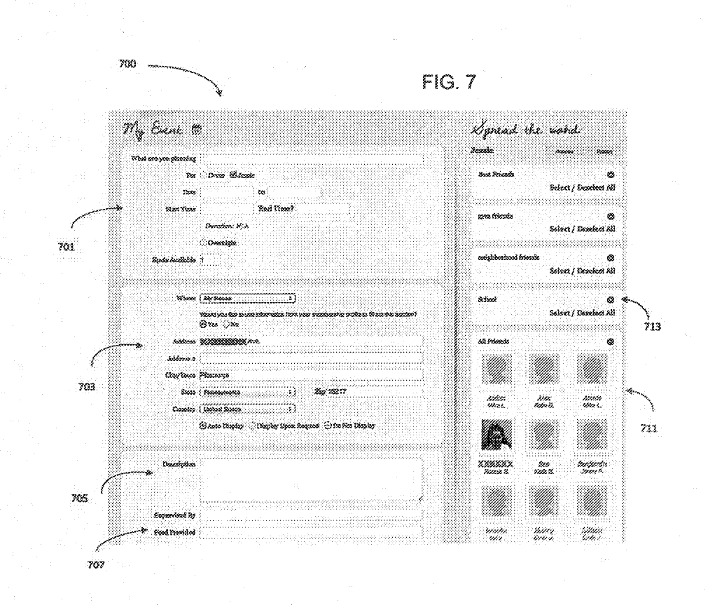

FIG. 7 illustrates an example of a social event creation interface 700 for a scheduling system. The social scheduler allows users to post events to one or more social connections. The user may give the event a name, title or other identifier 701; select the associated entity who the event is for; and enter information about the event such as date and time.

The user may be required to identify how many spaces are available for the event. When all spaces are taken, the event may be considered full and no additional invitations will be accepted. In the play date version, this reflects how many kids the host is willing to have for the play date. If it were a car pool, this may reflect how many seats were available in the host's car.

When choosing the location 703 for the event, if the user has entered her address into her profile, and if she chooses her house as the location, the social scheduler may pull that address information from the database and automatically enter it onto the screen. The user may keep that information or choose a different location and add the address manually. This field can be modified for different uses of the invention so that, for example, in a car pooling site, the field could reflect pick-up and drop-off locations at the driver's home, a passenger's home, or a public location.

The user may be permitted to enter an optional description of the event and can choose to add one or more characteristics 705 of the event or its location, such as whether food will be served. This field can be modified as needed for the event. For example, in a car pooling site, the field could simply receive any needed notes or comments, or a parent of young children might indicate how many car-seats or boosters she has available.

For safety purposes, the user may be required to identify a person who is in charge 707 of the social event. In a play date site, this may indicate who will be watching the children—e.g., mom, dad, nanny, grandma, etc. Similarly, for carpooling, the field would identify who would be driving.

All of the information may be captured in the database and available for the recipients of the social invitation, or for the system to use when comparing invitee restrictions with event or host site characteristics

The user selects which social connections to invite. When the user identifies the associated entity (e.g., child) for whom the event is being planned, the system may automatically display that associated entity's connections 711. If the user has created groups 713, the system may display those as well. Each group can expand to show its members or collapse. The user may select one or more groups, one or more individuals, all social connections, or any combination thereof by selecting and deselecting social connections. Optionally, the user may invite more guests than the number of slots available to help ensure that the social engagement is filled.

When a social event is created by the host, the system may create and display a preview of the event before sending out any invitations. A preview screen may display some or all of the information about the event for the user's review. In some embodiments, the invitation and/or the preview screen may be integrated with a mapping application to provide a map that includes the event's location.

Once a member has edited any information as necessary in his event, he can enter a command to cause the system to disseminate the invitation to his invited guests. In some embodiments, the user may be able to assign a recurrence to the event, such as weekly, bi-weekly or monthly. If so, the user may instruct the system to send a single invitation for all occurrences of the event. Alternatively, the user may instruct the system to send separate invitations for each occurrence, with each invitation sent within a specified time period before each occurrence.

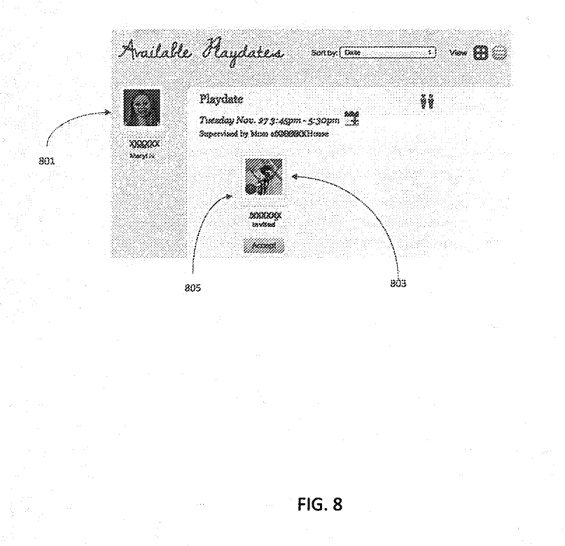

Any invitee may receive the invitation via an e-mail, text message, mobile application notification, or other message or alert. The message may include a link or other command that takes the user to a site or application where the invitee may view the social invitation, as illustrated in FIG. 8. For example, an invited child's 803 parent can see her play date invitation from the child's friend 801. The parent can accept that invitation on the child's behalf if she wishes to do so.

In some embodiments, before creating the invitation, the system may compare the invitee's profile information—and in particular any special needs information—to the host facility's or event characteristics to determine whether the characteristics conflict with the special needs information. If so, it may generate an alert 805, such as a symbol or text over an icon or photo that is included in the invitation. The alert may display or link to any special needs information or certain data that is in the child's profile, such as allergies, medical info, emergency contact names and numbers, etc. In this case, the allergy info—showing that the invited guest is allergic to dogs—is featured an alert because the host's home has dogs.

If the user wishes to ask the host's parent a question (perhaps about the dogs), the user may be permitted to select a message function to create a message for the host. In some embodiments, the user may also be enabled to export the social engagement to a separate calendar application. If the user wants directions to the event, the user may be provided with a link to a mapping application that provides directions to the address if the host has entered that information.

The system also may include a dashboard by which a user can view the social engagements that he has created, or the social engagements to which he and/or his associated entity has been invited.

Any time that a host edits or cancels a social event, the system may cause a notification of the same to be transmitted to the invitees. All confirmed parties also may receive a reminder e-mail message a certain time before the scheduled event, such as one day before the event.

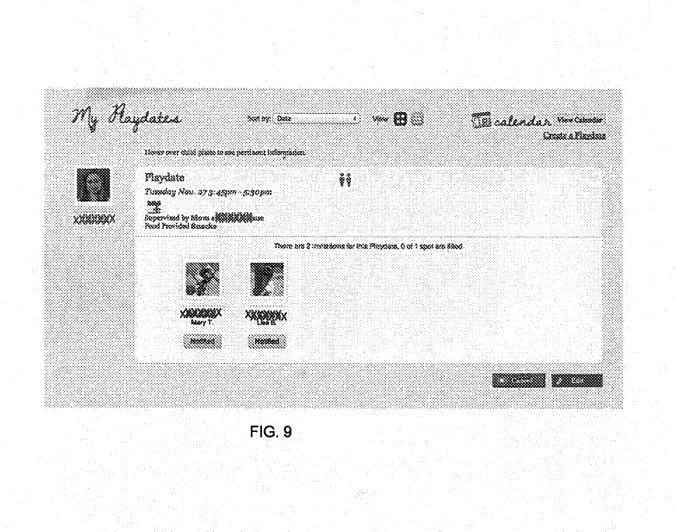

As illustrated in FIG. 9, if there are more invitees than there are spaces available for the social event, the scheduler will allow invitees to accept on a first come first served basis up to the number of spaces available. After that time, any user attempting to accept will receive a message stating that the event is already filled, and the event may no longer appear as an available social engagement. The creator of the social event may receive a message alerting him each time someone has accepted his invitation.

The system may provide a calendar interface by which a user can view all of her social engagements, including those she has created and those which others have created and sent her an invitation to attend. The calendar may color-code the entries or filter them by any predetermined or user-determined criteria. The calendar interface may also filter the social engagements by associated entity (e.g., if user has two children, she can view play dates for one or both). The application may indicate whether each social engagement has been confirmed (i.e., if the user is the one to have been invited, whether the user has accepted; if the user has extended the invitation, if anyone has yet accepted). The calendar application may show a brief summary of the event. If the user clicks on the summary, the system may provide a link to additional information (such as who is supervising the play date and its location).

In some embodiments that enable the scheduling of play dates, the system could allow interested parents to search out new friends for their children by zip code, gender, and/or age of child and then invite those parents to connect with the intention of creating a future play date. In some embodiments, the system could also be used to allow children separated by distance or who have limited options for in-person play dates due to a physical or emotional limitation or other special need to plan a play date that occurs virtually via a video conferencing application. As with a play date, the system may be used to plan carpools because parents could use the process to offer and accept carpool invitations, limiting slots to seats available in the driver's car. The system also could have applicability for get-togethers for parents only without children, party planning, and pet play dates.

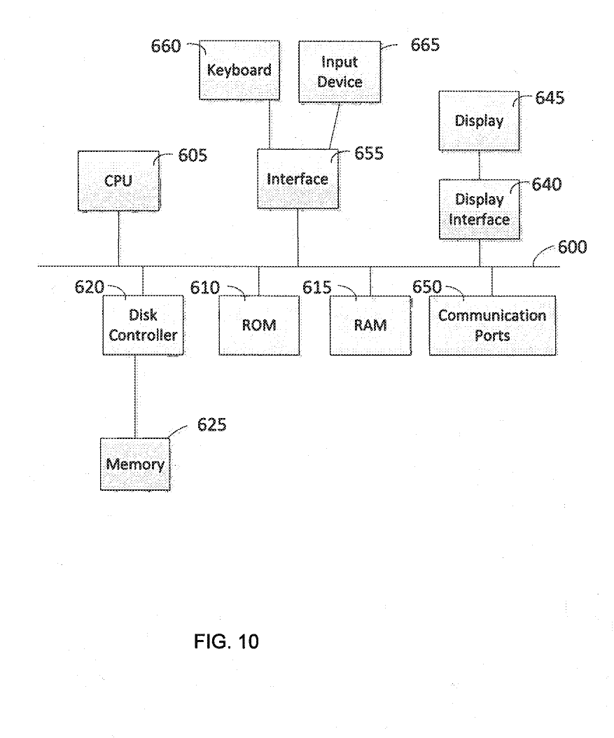

FIG. 10 depicts a block diagram of internal hardware that may be used to contain or implement program instructions according to an embodiment. A bus 600 serves as the main information highway interconnecting the other illustrated components of the hardware. CPU 605 is the central processing unit of the system, performing calculations and logic operations required to execute a program. Read only memory (ROM) 610 and random access memory (RAM) 615 constitute exemplary memory devices.

A controller 620 interfaces with one or more optional memory devices 625 to the system bus 600. These memory devices 625 may include, for example, an external or internal DVD drive, a CD ROM drive, a hard drive, flash memory, a USB drive or the like. As indicated previously, these various drives and controllers are optional devices.

Program instructions may be stored in the ROM 610 and/or the RAM 615. Optionally, program instructions may be stored on a tangible computer readable storage medium such as a compact disk, a digital disk, flash memory, a memory card, a USB drive, an optical disc storage medium and/or other recording medium.

An optional display interface 330 may permit information from the bus 600 to be displayed on the display 635 in audio, visual, graphic or alphanumeric format. Communication with external devices may occur using various communication ports 640. In some implementations, a communication port 640 may be attached to a communications network, such as the Internet or an intranet.

The hardware may also include an interface 645 which allows for receipt of data from input devices such as a keyboard 650 or other input device 655 such as a mouse, a joystick, a touch screen, a remote control, a pointing device, a video input device and/or an audio input device.

The features and functions disclosed above, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A method for invitee scheduling with acceptance limits, comprising (A) a social event creation interface stored on non-transitory computer-readable program code and executed by a processor configured for determining a number of invitees (x) from a population set; determining a numerical limit for acceptances (y), and for being populated with a scheduler profile that stores profile responses descriptive of said scheduler and characteristics of associated entities and event data input to said scheduler profile fields, and for being populated with a plurality of invitee profiles descriptive of said invitee in said population set, (B) an executable message manager that communicates to a network and is configured to send a social event invitation message to said invitees, wherein said social event invitation message includes event data descriptive of the social event, said numerical limit for acceptances, and optionally one or more needs identifier; said message manager configured for receiving via said network messages from said invitees, such that when said numerical limit for acceptances is received said message manager sends a notification to said scheduler, and sends a confirmation of acceptance to invitees who accepted before said numerical limit for acceptances (y) was reached, and a notification to responding invitees that the social event limit was met; and (C) a cache for storing predetermined group characteristics associated with data in profiles for some of said invitees within said population set said cache accessible by said social event creation interface.

2. A social scheduling system comprising:
a data storage facility that stores a plurality of member profiles for members of a social network, wherein each member profile includes information identifying the member as well as at least one associated entity;
a scheduling module that is configured to:
receive, from a host member who is one of the members of the network, an identifier, a time, a location, and a plurality of invitees for a social event;
create a social invitation, the social invitation comprising the identifier, time, location and number of spaces available for the social event;
cause the social invitation to be transmitted to each member whose associated entity is one of the invitees;
receive, from a plurality of the members who received the social invitation, a plurality of acceptances for the invitees;
after receiving each acceptance, whether a total number of the acceptances received exceeds the number of spaces available;
for each invitee who accepts before the number of spaces available has been exceeded, causing a confirmation of the acceptance to be presented to the invitee's associated member;
for each invitee who attempts to accept when the number of spaces available has been exceeded, causing a notification that the event is full to be presented to the associated member who attempts to accept.

3. The system of claim 2, wherein before causing the social invitation to be transmitted, the scheduling module is further configured to:
determine whether each of the invitees' associated entities is a member of said social network;
for each invitee who is not a member of said social network, causing an invitation to join said social network to be transmitted to the invitee, and requiring the invitee to join said social network before the invitee may accept the social invitation.

4. The system of claim 2, wherein:
said each associated entity is a child for whom the associated member is a parent or guardian;
said each member profile comprises personally-identifying information for the associated entity child that includes one or more of the following: name, gender, or age-related information;
at least some of the member profiles for the invitees comprise a special needs identifier for the invitee's child; and
said scheduling module is further configured to:
before sending an invitation to an invitee, determine whether the invitee's member profile includes a special needs identifier; and
for each invitee whose member profile includes a special needs identifier, cause a notification of the acceptance to be presented to the host member such that the notification includes indicia of the special needs identifier.

5. The system of claim 4, wherein:
the special needs identifier comprises an allergy; and
the indicia of the special needs identifier comprises a description of the allergy.

6. The system of claim 2, wherein:
said each associated entity is a child for whom the corresponding member is a parent or guardian;
said each member profile comprises personally-identifying information for the associated entity child that includes one or more of the following: name, gender, or age-related information;
at least some of the member profiles for the invitees comprise a special needs identifier for the invitee's child; and
said scheduling module is further configured to:
receive a characteristic of the social event,
before sending an invitation to an invitee, determine whether an invitee's member profile includes a special needs identifier; and
for each invitee whose member profile includes a special needs identifier, determine whether the special needs identifier conflicts with the characteristic of the social event; and
if the special needs identifier conflicts with the characteristic of the social event, cause an alert to presented to the host member, the invitee whose member profile includes the special needs identifier, or both.

7. The system of claim 6, wherein:
the special needs identifier comprises a pet allergy;
said characteristic of the social event comprises an indication of a pet that is present at the location; and
determining whether the special needs identifier conflicts with the characteristic of the social event comprises determining whether the pet may cause the child to adversely react due to the pet allergy.

8. The system of claim 6, wherein:
the special needs identifier comprises a food allergy;
said characteristic of the location comprises an indication of a food item will be served at the social event; and
determining whether the special needs identifier conflicts with the characteristic of the social event comprises determining whether the food item may cause the child to adversely react due to the food allergy.

9. The system of claim 2, wherein said scheduling module is further configured to:
enable the host member to assign a plurality of members of said social network to a group;
when receiving the plurality of invitees for a social event from the host member, the receiving comprises receiving an identifier of the group.

10. A social scheduling system comprising:
a data storage facility that stores a plurality of member profiles for members of a network, wherein each member profile includes information identifying the member as well as at least one associated entity;
a scheduling module that is configured to:
receive, from a host member who is one of the members of the network, an identifier, a time, a location, and at least one invitees for a social event;
receive a characteristic of the social event;
create a social invitation, the social invitation comprising the identifier, a time, a and a location for the social event;
cause the social invitation to be transmitted to each of the invitees;
determine whether any invitee's member profile includes a special needs identifier for the invitee's associated entity, and for each invitee whose member profile includes a special needs identifier,
determine whether the special needs identifier conflicts with the characteristic of the social event, and
if the special needs identifier conflicts with the characteristic of the social event, cause an alert to presented to the host member, the invitee whose member profile includes the special needs identifier, or both.

11. The system of claim 6, wherein:
the special needs identifier comprises a pet allergy;
the characteristic of the social event comprises an indication of a pet that is present at the location; and
determining whether the special needs identifier conflicts with the characteristic of the social event comprises determining whether the pet may cause the invitee's associated entity to adversely react due to the pet allergy.

12. The system of claim 6, wherein:
the special needs identifier comprises a food allergy;
the characteristic of the location comprises an indication of a food item will be served at the social event; and
determining whether the special needs identifier conflicts with the characteristic of the social event comprises determining whether the food item may cause the invitee's associated entity to adversely react due to the food allergy.

13. The system of claim 6, wherein before causing the social invitation to be transmitted, the scheduling module is further configured to:
determine whether each of the invitees' is a member of the network;
for each invitee who is not a member of the network, causing an invitation to join said social network to be transmitted to the invitee, and requiring the invitee to join the network before the invitee may accept the social invitation.

14. The system of claim 2, wherein:
said member profile for said host member that includes at least one associated entity, wherein said associated entity is a child for whom said host member is a parent or guardian; and
said scheduling module is further configured to:
enable said host member to assign a first plurality of members of said social network to a unique set of friends for each child of said host member;
upon receipt of said identifier for the social event and an indication of which of said host member's children is affiliated with said social event, present said host member with a displayed set of the associated entity child's friends; and
receive, from said host member, a selection of the at least one invitees as a selection from said displayed set of friends.

15. The method for invitee scheduling with acceptance limits of claim 1, wherein:
said cache and said processor enable said scheduler to assign a recurrence to said social event, and send a social event invitation to said invitees (x) from said population set.

16. The method for invitee scheduling with acceptance limits of claim 1, wherein:
said cache and said processor enable said scheduler to reschedule said social event and to resend a social event invitation to said invitees within said population set.
